(19) United States
(12) Patent Application Publication
(10) Pub. No.: US 2024/0015586 A1
(43) Pub. Date: Jan. 11, 2024

(54) PREDICTIVE ADAPTATION FOR A WIRELESS LINK

(71) Applicant: QUALCOMM Incorporated, San Diego, CA (US)

(72) Inventors: Nikolai Konrad LEUNG, San Francisco, CA (US); Peerapol TINNAKORNSRISUPHAP, San Diego, CA (US); Hussein METWALY SAAD, San Diego, CA (US); Simone MERLIN, San Diego, CA (US); Thomas STOCKHAMMER, Bergen (DE)

(21) Appl. No.: 17/811,207

(22) Filed: Jul. 7, 2022

(51) Int. Cl. H04W 28/06; H04W 24/02

(52) U.S. Cl. CPC H04W 28/06; H04W 24/02

(57) ABSTRACT

Various aspects of the present disclosure generally relate to wireless communication. In some aspects, a first wireless communication device (WCD) may communicate a first set of data packets with a second WCD via a wireless link using a first set of one or more parameters. The WCD may obtain environmental information associated with an environment of the first WCD or the second WCD. The WCD may detect, based at least in part on the environmental information, a predicted increase of packet loss for a subsequent period of time. The WCD may communicate a second set of data packets with the second WCD via the wireless link using a second set of one or more parameters, the second set of one or more parameters based at least in part on detection of the predicted increase of packet loss. Numerous other aspects are described.

### FIELD OF THE DISCLOSURE

Aspects of the present disclosure generally relate to wireless communication and to techniques and apparatuses for predictive adaptation for a wireless link.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a first wireless communication device (WCD). The method may include communicating a first set of data packets with a second WCD via a wireless link using a first set of one or more parameters. The method may include obtaining environmental information associated with an environment of the first WCD or the second WCD. The method may include detecting, based at least in part on the environmental information, a predicted increase of degradation of communications for a subsequent period of time, the predicted degradation of communications comprising one or more of a predicted increase of packet loss of communications, a predicted increase of latency to a multimedia layer of communications, or an increased latency to a codec layer of communications. The method may include communicating a second set of data packets with the second WCD via the wireless link using a second set of one or more parameters, the second set of one or more parameters based at least in part on detection of the predicted increase of degradation of communications.

Some aspects described herein relate to a first wireless communication device (WCD) for wireless communication. The first wireless communication device may include a memory and one or more processors coupled to the memory. The one or more processors may be configured to communicate a first set of data packets with a second WCD via a wireless link using a first set of one or more parameters. The one or more processors may be configured to obtain environmental information associated with an environment of the first WCD or the second WCD. The one or more processors may be configured to detect, based at least in part on the environmental information, a predicted increase of degradation of communications for a subsequent period of time, the predicted degradation of communications comprising one or more of a predicted increase of packet loss of communications, a predicted increase of latency to a multimedia layer of communications, or an increased latency to a codec layer of communications. The one or more processors may be configured to communicate a second set of data packets with the second WCD via the wireless link using a second set of one or more parameters, the second set of one or more parameters based at least in part on detection of the predicted increase of degradation of communications.

Some aspects described herein relate to a non-transitory computer-readable medium that stores a set of instructions for wireless communication by a first wireless communication device (WCD). The set of instructions, when executed by one or more processors of the WCD, may cause the WCD to communicate a first set of data packets with a second WCD via a wireless link using a first set of one or more parameters. The set of instructions, when executed by one or more processors of the WCD, may cause the WCD to obtain environmental information associated with an environment of the first WCD or the second WCD. The set of instructions, when executed by one or more processors of the WCD, may cause the WCD to detect, based at least in part on the environmental information, a predicted increase of degradation of communications for a subsequent period of time, the predicted degradation of communications comprising one or more of a predicted increase of packet loss of communications, a predicted increase of latency to a multimedia layer of communications, or an increased latency to a codec layer of communications. The set of instructions, when executed by one or more processors of the WCD, may cause the WCD to communicate a second set of data packets with the second WCD via the wireless link using a second set of one or more parameters, the second set of one or more parameters based at least in part on detection of the predicted increase of degradation of communications.

Some aspects described herein relate to an apparatus for wireless communication. The apparatus may include means for communicating a first set of data packets with a second WCD via a wireless link using a first set of one or more parameters. The apparatus may include means for obtaining environmental information associated with an environment of the first WCD or the second WCD. The apparatus may include means for detecting, based at least in part on the environmental information, a predicted increase of degradation of communications for a subsequent period of time, the predicted degradation of communications comprising one or more of a predicted increase of packet loss of communications, a predicted increase of latency to a multimedia layer of communications, or an increased latency to a codec layer of communications. The apparatus may include means for communicating a second set of data packets with the second WCD via the wireless link using a second set of one or more parameters, the second set of one or more parameters based at least in part on detection of the predicted increase of degradation of communications.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a UE in a wireless network, in accordance with the present disclosure.

FIG. 3 is a diagram illustrating an example disaggregated base station architecture, in accordance with the present disclosure.

FIG. 4 is a diagram illustrating an example of communications via a wireless link between a network node and a UE.

FIGS. 5-11 are diagrams of examples associated with predictive adaptation for a wireless link, in accordance with the present disclosure.

FIG. 12 is a diagram illustrating an example process performed, for example, by a first WCD, in accordance with the present disclosure.

FIG. 13 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

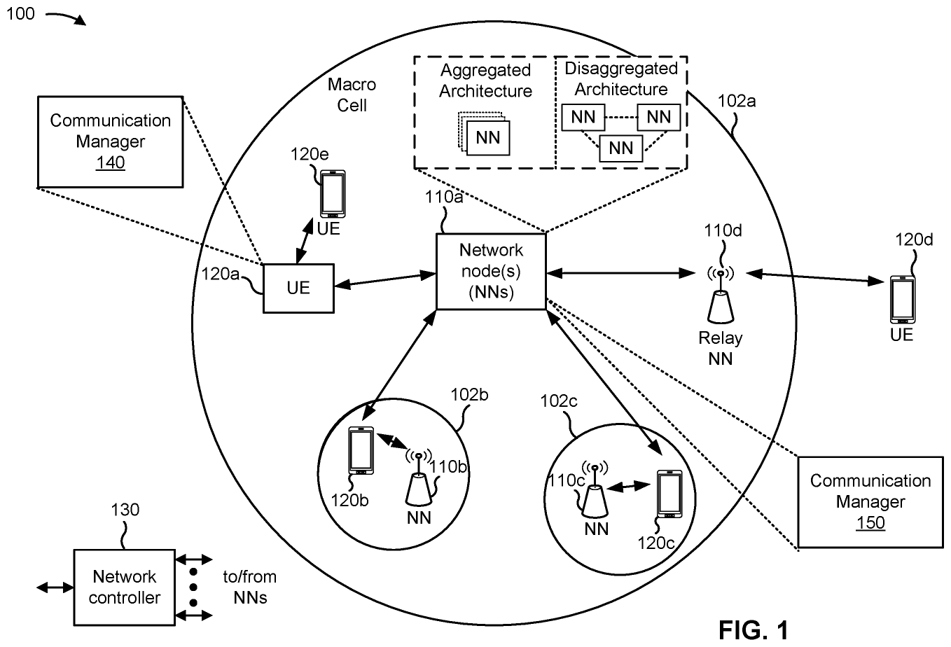

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first WCD (e.g., UE 120 or network node 110) may include a communication manager 140 or 150. As described in more detail elsewhere herein, the communication manager 140 or 150 may communicate a first set of data packets with a second WCD via a wireless link using a first set of one or more parameters; obtain environmental information associated with an environment of the first WCD or the second WCD; detect, based at least in part on the environmental information, a predicted increase of degradation of communications for a subsequent period of time, the predicted degradation of communications comprising one or more of a predicted increase of packet loss of communications, a predicted increase of latency to a multimedia layer of communications, or an increased latency to a codec layer of communications; and communicate a second set of data packets with the second WCD via the wireless link using a second set of one or more parameters, the second set of one or more parameters based at least in part on detection of the predicted increase of degradation of communications. Additionally, or alternatively, the communication manager 140 or 150 may perform one or more other operations described herein.

As indicated above, FIG. 1 is provided as an example. Other examples may differ from what is described with regard to FIG. 1.

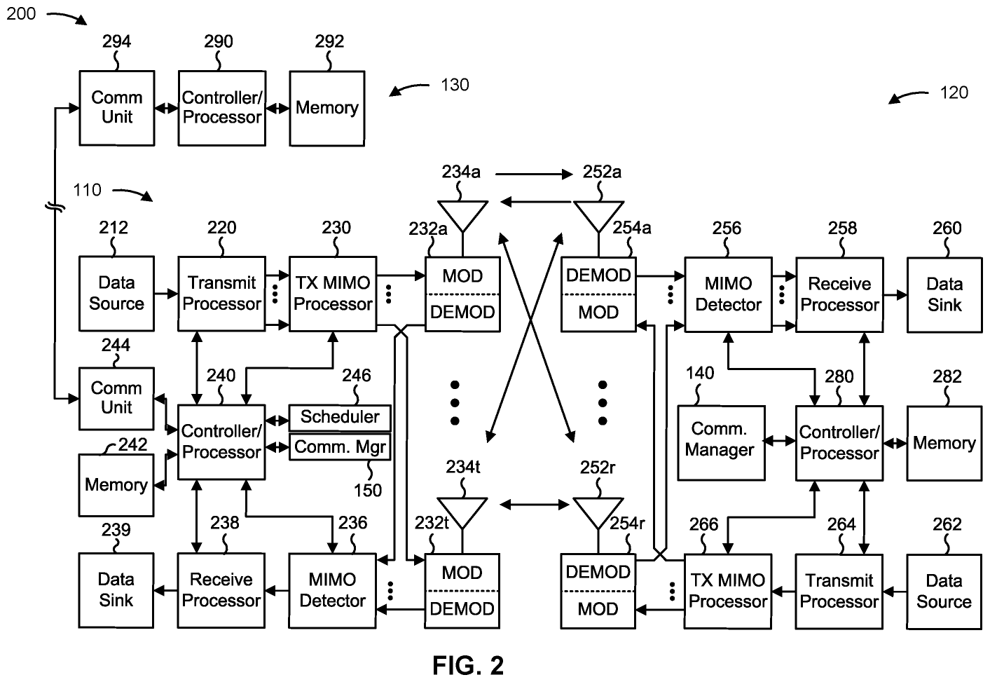

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

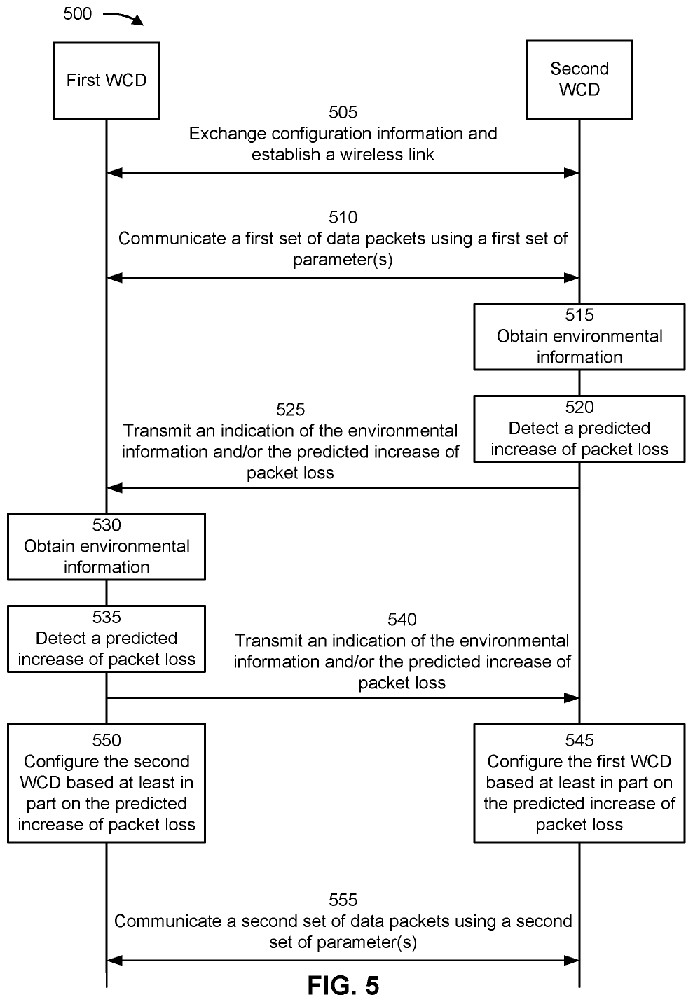

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-13).

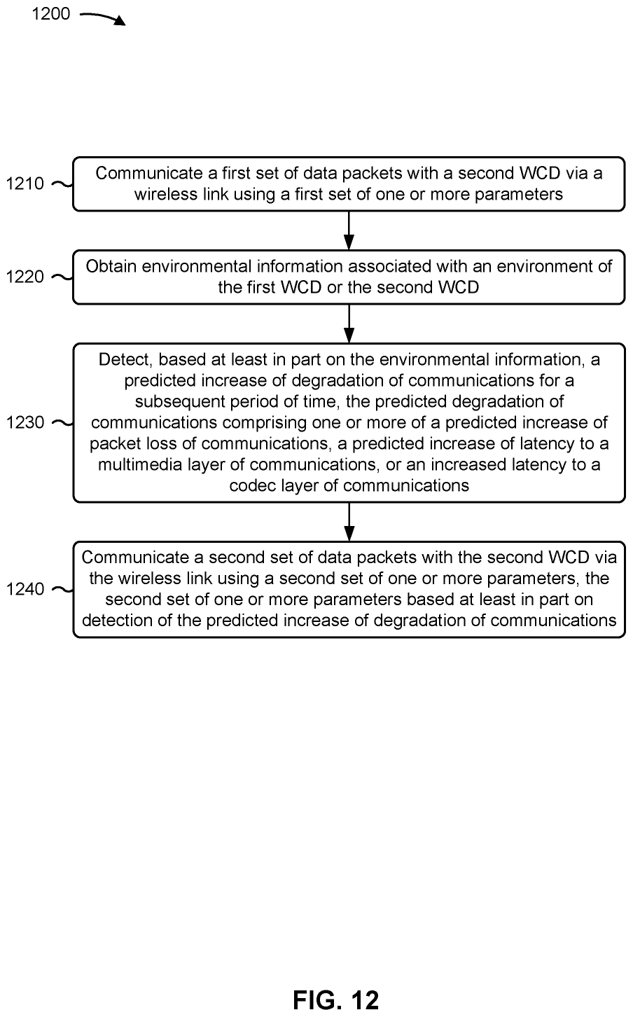

The controller/processor 240 of the network node 110, the controller/processor 280 of the UE 120, and/or any other component(s) of FIG. 2 may perform one or more techniques associated with predictive adaptation for a wireless link, as described in more detail elsewhere herein. In some aspects, the first WCD and/or the second WCD described herein is the network node 110, is included in the network node 110, or includes one or more components of the network node 110 shown in FIG. 2. In some aspects, the first WCD and/or the second WCD described herein is the UE 120, is included in the UE 120, or includes one or more components of the UE 120 as shown in FIG. 2. For example, the controller/processor 240 of the network node 110, the controller/processor 280 of the UE 120, and/or any other component(s) of FIG. 2 may perform or direct operations of, for example, process 1200 of FIG. 12 and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1200 of FIG. 12 and/or other processes as described herein. In some examples, executing instructions may include running the instructions, converting the instructions, compiling the instructions, and/or interpreting the instructions, among other examples.

In some aspects, the first WCD includes means for communicating a first set of data packets with a second WCD via a wireless link using a first set of one or more parameters; means for obtaining environmental information associated with an environment of the first WCD or the second WCD; means for detecting, based at least in part on the environmental information, a predicted increase of degradation of communications for a subsequent period of time, the predicted degradation of communications comprising one or more of a predicted increase of packet loss of communications, a predicted increase of latency to a multimedia layer of communications, or an increased latency to a codec layer of communications; and/or means for communicating a second set of data packets with the second WCD via the wireless link using a second set of one or more parameters, the second set of one or more parameters based at least in part on detection of the predicted increase of degradation of communications. In some aspects, the means for the first WCD to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the first WCD to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

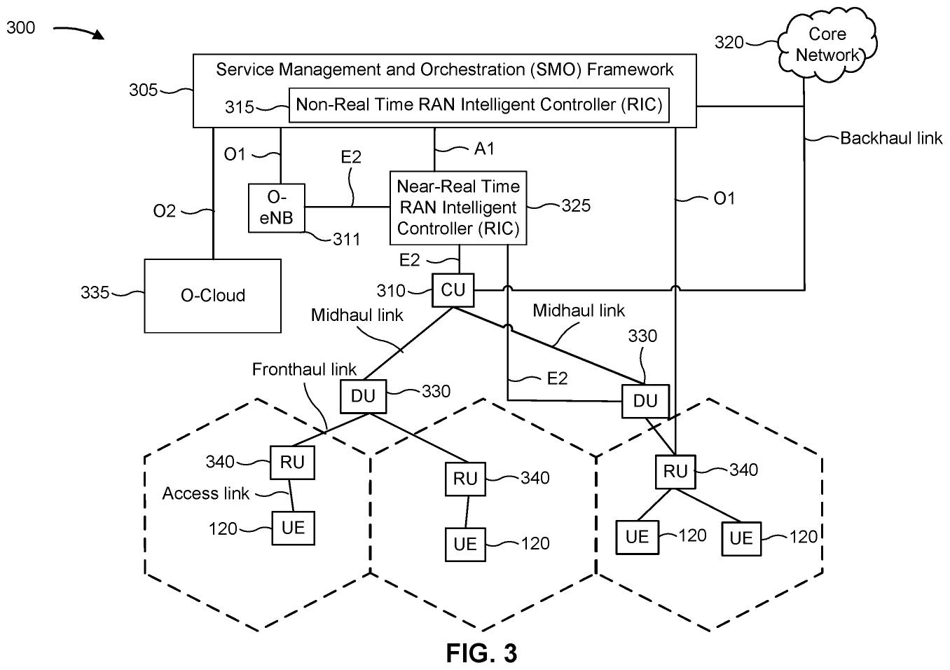

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 335) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

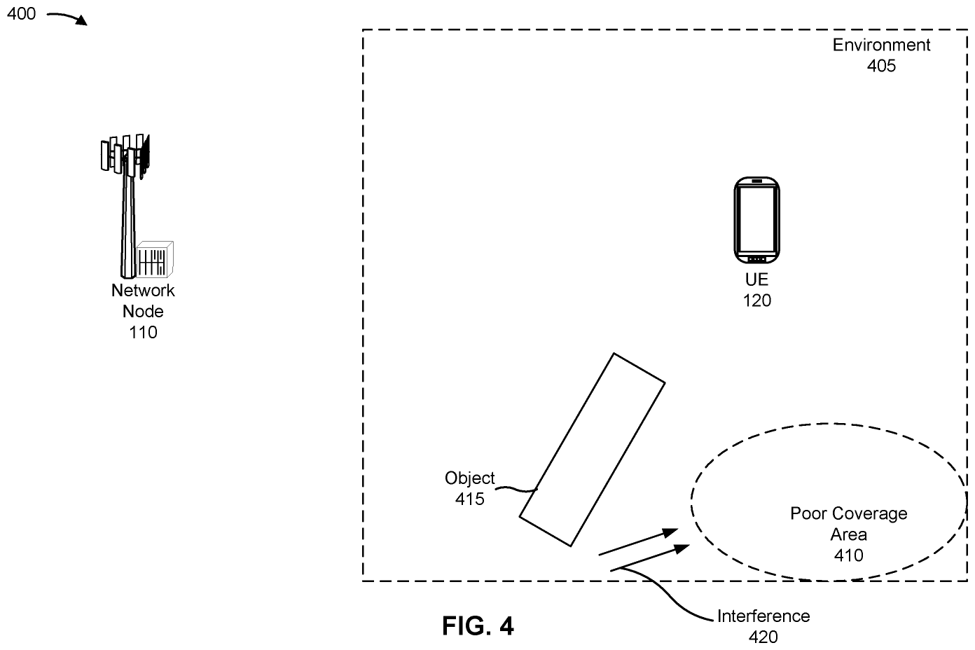

FIG. 4 is a diagram illustrating an example 400 of communications via a wireless link between a network node 110 and a UE 120. The UE 120 may be in an environment 405 (e.g., a physical environment) that includes one or more objects, interference, and/or weather-based factors, among other examples that may affect the wireless link.

The environment 405 may include a poor coverage area 410. The poor coverage area 410 may be associated with an increased error rate, a radio link failure, and/or use of communication parameters with reduced spectral efficiency relative to other areas of the environment 405. For example, the poor coverage area 410 may have poor coverage (e.g., relative to the other areas of the environment 405) based at least in part on an object 415 being positioned between the network node 110 and the poor coverage area 410. Additionally, or alternatively, the poor coverage area 410 may have poor coverage based at least in part on interference 420 in the poor coverage area 410. For example, the interference 420 may be associated with an additional communication link between a WCD and the network node 110, the UE 120, or an additional WCD, among other examples. In some examples, the interference 420 may be associated with a device that is not a WCD that generates electromagnetic waves for non-communication purposes.

In some examples, the UE 120 may communicate with the network node 110 to transmit and/or receive data packets associated with a video, audio, and/or extended reality (XR) stream, among other examples. In this case, entering the poor coverage area 410 may cause uplink and/or downlink data packets to be lost. This may cause degradation of the video, audio, and/or XR stream. Additionally, or alternatively, this may result in re-transmission of lost data packets (consuming power, computing, communication, and/or network resources), failures to satisfy latency requirements, and/or violations of quality of service (QoS) requirements, among other examples.

As indicated above, FIG. 4 is provided as an example. Other examples may differ from what is described with regard to FIG. 4.

In some aspects described herein, a network node and/or a UE may detect a predicted increase of packet loss for a subsequent period of time based at least in part on environmental information. For example, the network node and/or the UE may detect the predicted increase of packet loss based at least in part on sensory information of an environment. The sensory information may detect, for example, an object that may block communications between the UE and the network node, an area with increased interference, and/or an area with inclement weather that may affect signal propagation, among other examples. The network node and/or the UE may predict the increase of packet loss based at least in part on a trajectory of movement of the UE, an orientation of the UE, and/or a location of the UE relative to a predicted poor coverage area of the environment.

In some aspects, the UE and/or the network node may provide an indication of the predicted increase of packet loss to the other, and/or the UE and/or the network node may provide an indication of the predicted increase of packet loss to an application server communicating a video, audio, and/or XR stream with the UE.

Based at least in part on detecting the predicted increase of packet loss, the UE, the network node, and/or the application server may communicate via wireless link with a set of one or more parameters associated with the predicted increase of packet loss. For example, a device (e.g., the UE or the application server) generating packets for transmission during the predicted increase of packet loss may mitigate effects of the packet loss based at least in part on configuring one or more parameters of communications before, during, and/or after a period of time associated with the packet loss. In some aspects, an encoder (e.g., the device generating the packets, such as the UE or the application server) may use a reduced quality or frame rate to reduce a data rate. In some aspects, the encoder may use a higher bandwidth before the period of time to send information that will help improve the quality during the period of time. This may degrade a quality of a transmission prior to the period of time, but may also reduce a quality degradation during the period of time and/or may smoothen a transition to the period of time to avoid a sudden quality drop or frame freeze. In some aspects, if the encoder is sending intra-coded blocks, the encoder may use time preceding the time period to send increased intra-coded information based at least in part on an expectation that the encoder will have reduced bandwidth during period of time. In some aspects, if sending only a viewport of a 360-degree video (e.g., to a decoder, such as the UE or the application server), the encoder may encode margins beyond the current viewport (e.g., with reduced quality). In some aspects, if sending 3D data such as vector streaming or scene description, the encoder may update and/or widen coverage of the 3D information prior to the blockage so that the decoder may use most-up-to-date 3D information to perform rendering during the period of time. In some aspects, if the encoder is also given information predicting higher packet loss during blockage, the encoder may be configured, based at least in part on estimating an end of the period of time, to send intra-refresh and/or I-frames to clear up video artifacts due to potential packet losses during the period of time.

In some aspects, the UE, the network node, and/or the application server may obtain the environmental information via sensors local to the UE, sensors local to the network node, and/or sensors local to another device.

Based at least in part on the UE, the network node, and/or the application server obtaining the environmental information and/or detecting a predicted increase of packet loss, the UE, the network node, and/or the application server may mitigate effects of an increase of packet loss, which may reduce degradation of a video, audio, and/or XR stream associated with a wireless link between the UE and the network node. Additionally, or alternatively, the mitigation may reduce re-transmissions of lost data packets (which may conserve power, computing, communication, and/or network resources), failures to satisfy latency requirements, and/or violations of QoS requirements, among other examples.

FIG. 5 is a diagram of an example 500 associated with predictive adaptation for a wireless link, in accordance with the present disclosure. As shown in FIG. 5, a first WCD (e.g., a UE, a network node, a network node 110, a CU, a DU, and/or an RU) may communicate with a second WCD (e.g., a UE, a network node, a network node 110, a CU, a DU, and/or an RU). In some aspects, the first WCD and the second WCD may be part of a wireless network (e.g., wireless network 100).

As shown by reference number 505, first WCD and the second WCD may exchange configuration information and establish a wireless link. In some aspects, the first WCD may provide first configuration information via one or more of RRC signaling, one or more medium access control (MAC) control elements (CEs), and/or downlink control information (DCI), among other examples. In some aspects, the first configuration information may include an indication of one or more configuration parameters (e.g., already known to the second WCD and/or previously indicated by the network node or other network device) for selection by the second WCD, and/or explicit configuration information for the second WCD to use to configure the second WCD, among other examples. In some aspects, the second WCD may provide second configuration information to the second WCD, such as a capability report.

In some aspects, the configuration information may indicate that the second WCD is to obtain environmental information and/or use the environmental information to predict an increase of degradation for a time period. In some aspects, the configuration information may indicate that the second WCD is to receive the environmental information via a sensor that is local to the second WCD or from the first WCD. In some aspects, the configuration information may indicate that the second WCD is to provide an indication of the environmental information and/or an indication of the predicted increase of degradation to the first WCD.

In some aspects, the configuration information may indicate that the first WCD is to obtain environmental information and/or use the environmental information to predict an increase of degradation for a time period. In some aspects, the configuration information may indicate that the first WCD is to receive the environmental information via a sensor that is local to the first WCD, from the second WCD, or from a third WCD. In some aspects, the configuration information may indicate that the first WCD is to provide an indication of the environmental information and/or an indication of the predicted increase of degradation to the second WCD.

The first WCD and the second WCD may configure themselves based at least in part on the configuration information. In some aspects, the first WCD and the second WCD may be configured to perform one or more operations described herein based at least in part on the configuration information.

As shown by reference number 510, the first WCD and the second WCD may communicate a first set of data packets using a first set of one or more parameters. In some aspects, the first set of one or more parameters may be associated with the first WCD and the second WCD being outside of a blockage location associated with an increase of degradation.

As shown by reference number 515, the second WCD may obtain environmental information. For example, the second WCD may receive sensory information from a sensor that is local to the second WCD. The sensory information may indicate locations of physical obstacles, interference, and/or weather-based factors that may affect the wireless link. In some aspects, the second WCD may receive the sensory information from the first WCD (e.g., as described in connection with reference number 540), a third WCD, and/or a network node (e.g., an edge node entity and/or a core network entity, among other examples).

As shown by reference number 520, the second WCD may detect a predicted increase of degradation of communications for a subsequent period of time. The predicted increase of degradation of communications may include a predicted increase of packet loss of communications, a predicted increase of latency to a multimedia layer of communications, and/or an increased latency to a codec layer of communications. For example, the second WCD may detect the predicted increase of degradation of communications based at least in part on the environmental information, a location of the second WCD or the first WCD, a movement trajectory of the second WCD or the first WCD (e.g., toward a poor coverage area), and/or an orientation of the second WCD or the first WCD. In some aspects, the second WCD may determine a start of the subsequent period of time associated with the increase of degradation of communications, an end of the subsequent period of time, one or more metrics associated with the predicted increase of degradation of communications (e.g., an amount of packet loss), and/or a requested data rate for the subsequent period of time, among other examples.

As shown by reference number 525, the second WCD may transmit, and the first WCD may receive, an indication of the environmental information and/or the predicted increase of degradation of communications. In some aspects, the indication of the predicted increase of degradation of communications may include an indication of a start of the subsequent period of time associated with the increase of degradation of communications, an indication of an end of the subsequent period of time (e.g., a duration of the subsequent period of time), one or more metrics associated with the predicted increase of degradation of communications (e.g., an amount of packet loss), and/or a requested data rate for the subsequent period of time, among other examples. In some aspects, the second WCD may provide the indication of the predicted increase of degradation of communications to an application server associated with the first set of data packets and the second set of data packets.

As shown by reference number 530, the first WCD may obtain environmental information. For example, the first WCD may receive sensory information from a sensor that is local to the first WCD. The sensory information may indicate locations of physical obstacles, interference, and/or weather-based factors that may affect the wireless link. In some aspects, the first WCD may receive the sensory information from the second WCD (e.g., as described in connection with reference number 525), a third WCD, and/or a network node (e.g., an edge node entity and/or a core network entity, among other examples).

As shown by reference number 535, the first WCD may detect a predicted increase of degradation of communications. For example, the first WCD may detect the predicted increase of degradation of communications based at least in part on the environmental information, a location of the second WCD or the first WCD, a movement trajectory of the second WCD or the first WCD (e.g., toward a poor coverage area), and/or an orientation of the second WCD or the first WCD. In some aspects, the first WCD may determine a start of the subsequent period of time associated with the increase of degradation of communications, an end of the subsequent period of time, one or more metrics associated with the predicted increase of degradation of communications (e.g., an amount of packet loss), and/or a requested data rate for the subsequent period of time, among other examples.

As shown by reference number 540, the first WCD may transmit, and the second WCD may receive, an indication of the environmental information and/or the predicted increase of degradation of communications. In some aspects, the indication of the predicted increase of degradation of communications may include an indication of a start of the subsequent period of time associated with the increase of degradation of communications, an indication of an end of the subsequent period of time (e.g., a duration of the subsequent period of time), one or more metrics associated with the predicted increase of degradation of communications (e.g., an amount of packet loss), and/or a requested data rate for the subsequent period of time, among other examples.

In some aspects, the first WCD may provide the indication of the predicted increase of degradation of communications to an application server associated with the first set of data packets and the second set of data packets.

As shown by reference number 545, the second WCD may configure the second WCD based at least in part on the predicted increase of degradation of communications.

As shown by reference number 550, the first WCD may configure the first WCD based at least in part on the predicted increase of degradation of communications.

As shown by reference number 555, the first WCD and the second WCD may communicate a second set of data packets using a second set of one or more parameters. In some aspects, the second set of one or more parameters are based at least in part on detection of the predicted increase of degradation of communications. For example, the second set of one or more parameters may be configured to mitigate an effect of the packet loss.

In some aspects, communicating with the second WCD via the wireless link using a second set of one or more parameters based at least in part on detection of the predicted increase of degradation of communications includes transmitting the second set of data packets to the second WCD using the second set of one or more parameters, or receiving the second set of data packets from the second WCD using the second set of one or more parameters based at least in part on transmitting, to the second WCD, an indication of the predicted increase of degradation of communications. In other words, the second WCD may be a receiver and/or decoder and the first WCD may be a transmitter and/or an encoder, or the first WCD may be a receiver and/or decoder and the second WCD may be a transmitter and/or an encoder.

In some aspects, receiving the second set of data packets using the second set of one or more parameters may include receiving, during the subsequent period of time, the second set of data packets with a reduced data rate relative the first set of data packets. For example, the second set of data packets may use a lower quality or a frame rate to achieve a reduced data rate. In some aspects, receiving the second set of data packets may include receiving, before the subsequent period of time, a third set of data packets with an increased bandwidth relative to the first set of data packets. In some aspects, receiving the second set of data packets may include receiving, before the subsequent period of time, the third set of data packets including added intra-coded information relative to the first set of data packets. In some aspects, receiving the second set of data packets may include receiving, before the subsequent period of time, the third set of data packets including information associated with an image, with the information including parts of an image outside of a current view. In some aspects, receiving the second set of data packets may include receiving, before the subsequent period of time, the third set of communications including information associated with the image, with the information including 3-dimensional information having widened coverage relative to the first set of data packets. In some aspects, receiving the second set of data packets may include receiving, after the subsequent period of time, a fourth set of data packets including independently decodable frames of the image.

In some aspects, transmitting the second set of data packets to the second WCD using the second set of one or more parameters includes transmitting, during the subsequent period of time, the second set of data packets with a reduced data rate relative the first set of data packets. In some aspects, transmitting the second set of data packets may include transmitting, before the subsequent period of time, a third set of data packets with an increased bandwidth relative to the first set of data packets. In some aspects, transmitting the second set of data packets may include transmitting, before the subsequent period of time, the third set of data packets including added intra-coded information relative to the first set of data packets. In some aspects, transmitting the second set of data packets may include transmitting, before the subsequent period of time, the third set of data packets including information associated with an image, with the information including parts of an image outside of a current view. In some aspects, transmitting the second set of data packets may include transmitting, before the subsequent period of time, the third set of communications including information associated with the image, with the information including 3-dimensional information having widened coverage relative to the first set of data packets. In some aspects, transmitting the second set of data packets may include transmitting after the subsequent period of time, a fourth set of data packets including independently decodable frames of the image.

In some aspects, communicating the second set of data packets with the second WCD via the wireless link using the second set of one or more parameters may include configuring an encoder or a decoder of the first WCD or the second WCD based at least in part on the predicted increase of degradation of communications for the subsequent period of time. In some aspects, communicating the second set of data packets with the second WCD via the wireless link using the second set of one or more parameters may include configuring a split-rendering configuration for dividing processing of the second set of data packets between a network node and one of the first WCD or the second WCD with the split-rendering configuration based at least in part on the predicted increase of degradation of communications for the subsequent period of time.

In some aspects, the first WCD or the second WCD may use the environmental information to detect an additional predicted increase of degradation of communications for an additional period of time for a third WCD associated with the environmental information. For example, based at least in part on the environmental information indicated by the second WCD, the first WCD may predict that a third WCD in the environment of the second WCD is likely to have an increase of degradation of communications (e.g., based at least in part on a location, an orientation, and/or a movement trajectory of the third WCD in the environment, among other examples). In this way the first WCD may use environmental information from the second WCD (e.g., as concurrent or historical data) to predict an increase of degradation of communications for a different WCD. The first WCD may adjust one or more parameters for communicating with the different WCD based at least in part on predicting the increase of degradation of communications.

In some aspects, the first set of data packets and/or the second set of data packets may include image data. In some aspects, the first set of data packets are associated with 2-dimensional image information and the second set of data packets are associated with 3-dimensional image information. In this way, in preparation for the predicted increase of degradation of communications, an encoder may provide 3-dimensional image information for a decoder to use to perform additional rendering operations during the period of time predicted to have an increase of degradation of communications and/or to reduce or avoid disruption in an image stream.

In some aspects, the first set of data packets are associated with audio input received at the first WCD or the second WCD and the second set of data packets are associated with predicted audio that is based at least in part on the audio input received at the first WCD or the second WCD. For example, based at least in part on predicting an increase in packet loss, the second set of data packets may use contextual information obtained from the first set of data packets to predict audio intended to be transmitted during the period of time associated with the increase in packet loss.

Based at least in part on the first WCD and/or the second WCD (e.g., the UE, the network node, and/or the application server) obtaining the environmental information and/or detecting a predicted increase of degradation of communications, first WCD, the second WCD may mitigate effects of an increase of degradation of communications, which may reduce degradation of a video, audio, and/or XR stream associated with a wireless link between the UE and the network node. Additionally, or alternatively, the mitigation may reduce re-transmissions of lost data packets (which may conserve power, computing, communication, and/or network resources), failures to satisfy latency requirements, and/or violations of QoS requirements, among other examples.

In some aspects, the first WCD and/or the second WCD may associate positions and/or orientations in a room with a blockage flag and/or a signal strength, among other examples, the first WCD and/or the second WCD may store this information (e.g., locally), such that when either of the WCDs or an additional device is at the same position, the first WCD and/or the second WCD may be aware of the environmental information (e.g., blockage information). In some aspects, the first WCD and/or the second WCD may predict blockage based at least in part on movement trajectory and use this information in rate allocation algorithms. In some aspects, the first WCD and/or the second WCD may share the environmental information with a cloud server to make this information accessible to the first WCD and/or the second WCD and/or to other devices to do blockage prediction. In some aspects, the first WCD and/or the second WCD may share the environmental information with a RAN network node and/or a network operator to improve coverage and/or to perform indoor ray tracing of 5G signals, among other examples. An associated network may relate positions of the first WCD and/or the second WCD to a geolocation and let the first WCD and/or the second WCD and/or other WCDs (e.g., network nodes) receive trackables, such as detectable spatial anchors.

As indicated above, FIG. 5 is provided as an example. Other examples may differ from what is described with respect to FIG. 5.

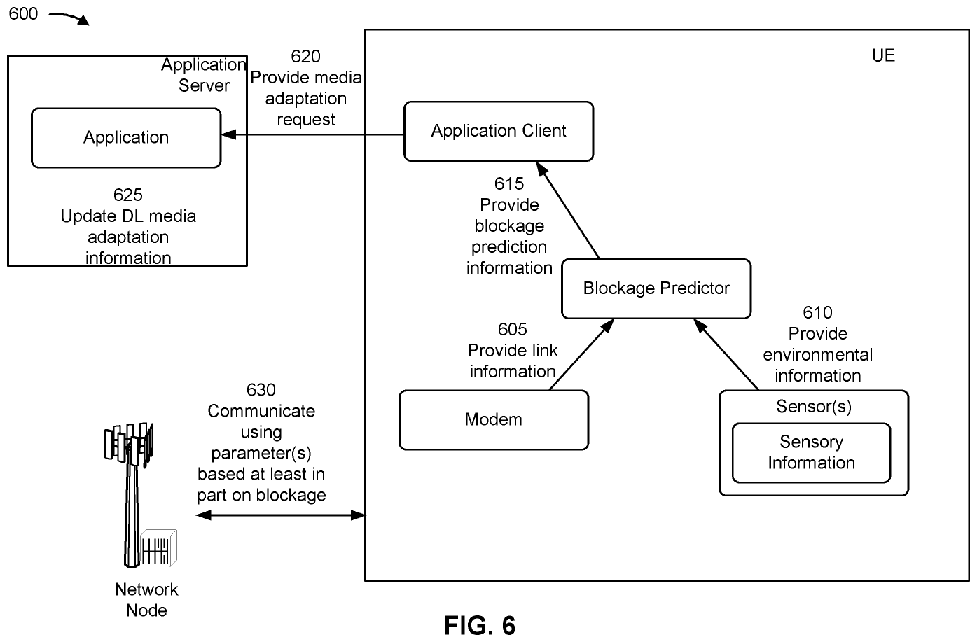

FIG. 6 is a diagram of an example 600 associated with predictive adaptation for a wireless link, in accordance with the present disclosure. As shown in FIG. 6, a UE may communicate with a network node (e.g., a network node 110, a CU, a DU, and/or an RU). In some aspects, the UE and the network node may be part of a wireless network (e.g., wireless network 100).

As shown in FIG. 6, and by reference number 605, a modem of the UE may provide a link information to a blockage predictor of the UE. The blockage predictor may include an entity of the UE that includes hardware of the UE, such as the modem, a processor, and/or memory of the UE.

As shown by reference number 610, one or more sensors of the UE may obtain sensory information and provide environmental information to the blockage predictor. In some aspects, the one or more sensors may include a camera, a radar, a lidar, and/or other device for detecting physical objects. In some aspects, the UE may obtain the sensory information from a connected device, such as an XR device that communications to the network node via the UE.

As shown by reference number 615, the blockage predictor may provide blockage prediction information to an application client of the UE. The blockage prediction information may include whether there is a blockage associated with an increase in packet loss, when the blockage is expected, a duration of the blockage, an effect of the blockage on the link, and/or a new downlink data rate to use and/or request, among other examples.

As shown by reference number 620, the application client may provide a media adaptation request to an application server. In some aspects, the application client may provide the media adaptation request to the application server via the modem of the UE and via the network node. In some aspects, the media adaptation request may include a request in an application layer of the link.

As shown by reference number 625, the application server may update downlink media adaptation information based at least in part on the media adaptation request.

As shown by reference number 630, the UE and the network node may communicate using one or more parameters that are based at least in part on the blockage. For example, the network node may carry communications between the application server and the UE based at least in part on the one or more parameters that are configured to mitigate the blockage.

As indicated above, FIG. 6 is provided as an example. Other examples may differ from what is described with respect to FIG. 6.

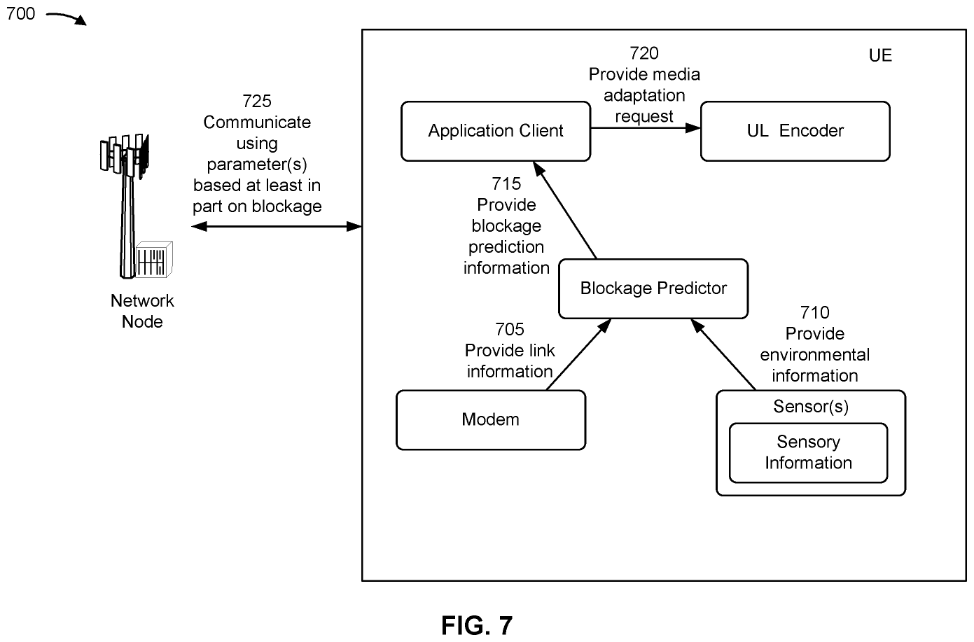

FIG. 7 is a diagram of an example 700 associated with predictive adaptation for a wireless link, in accordance with the present disclosure. As shown in FIG. 7, a UE may communicate with a network node (e.g., a network node 110, a CU, a DU, and/or an RU). In some aspects, the UE and the network node may be part of a wireless network (e.g., wireless network 100).

As shown in FIG. 7, and by reference number 705, a modem of the UE may provide a link information to a blockage predictor of the UE. The blockage predictor may include an entity of the UE that includes hardware of the UE, such as the modem, a processor, and/or memory of the UE.

As shown by reference number 710, one or more sensors of the UE may obtain sensory information and provide environmental information to the blockage predictor. In some aspects, the one or more sensors may include a camera, a radar, a lidar, and/or other device for detecting physical objects. In some aspects, the UE may obtain the sensory information from a connected device, such as an XR device that communications to the network node via the UE.

As shown by reference number 715, the blockage predictor may provide blockage prediction information to an application client of the UE. The blockage prediction information may include whether there is a blockage associated with an increase in packet loss, when the blockage is expected, a duration of the blockage, an effect of the blockage on the link, and/or a new downlink data rate to use and/or request, among other examples.

As shown by reference number 720, the application client may provide a media adaptation request to an uplink (UL) encoder of the UE for generating uplink communications. In some aspects, the UE may configure one or more parameters for transmitting an uplink communication based at least in part on the media adaptation request.

As shown by reference number 725, the UE and the network node may communicate using one or more parameters that are based at least in part on the blockage.

As indicated above, FIG. 7 is provided as an example. Other examples may differ from what is described with respect to FIG. 7.

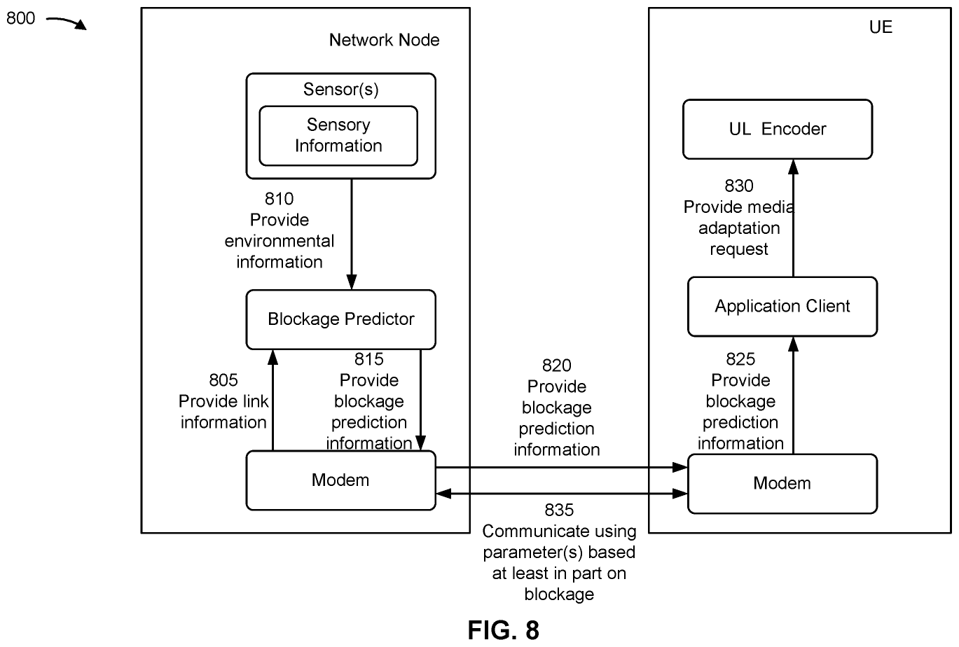

FIG. 8 is a diagram of an example 800 associated with predictive adaptation for a wireless link, in accordance with the present disclosure. As shown in FIG. 8, a UE may communicate with a network node (e.g., a network node 110, a CU, a DU, and/or an RU). In some aspects, the UE and the network node may be part of a wireless network (e.g., wireless network 100).

As shown in FIG. 8, and by reference number 805, a modem of the network node may provide a link information to a blockage predictor of the network node. The blockage predictor may include an entity of the network node that includes hardware of the network node, such as the modem, a processor, and/or memory of the network node.

As shown by reference number 810, one or more sensors of the network node may obtain sensory information and provide environmental information to the blockage predictor. In some aspects, the one or more sensors may include a camera, a radar, a lidar, and/or other device for detecting physical objects.

As shown by reference number 815, the blockage predictor may provide blockage prediction information to the modem of the network node. As shown by reference number 820, the modem of the network node may provide the blockage predication information (e.g., with or without adaptation from what was received from the blockage predictor) to a modem of the UE. As shown by reference number 825, the modem of the UE may provide the blockage prediction information to an application client of the UE.

As shown by reference number 830, the application client may provide a media adaptation request to an uplink encoder of the UE for generating uplink communications. In some aspects, the UE may configure one or more parameters for transmitting an uplink communication based at least in part on the media adaptation request.

As shown by reference number 835, the UE and the network node may communicate using one or more parameters that are based at least in part on the blockage.

As indicated above, FIG. 8 is provided as an example. Other examples may differ from what is described with respect to FIG. 8.

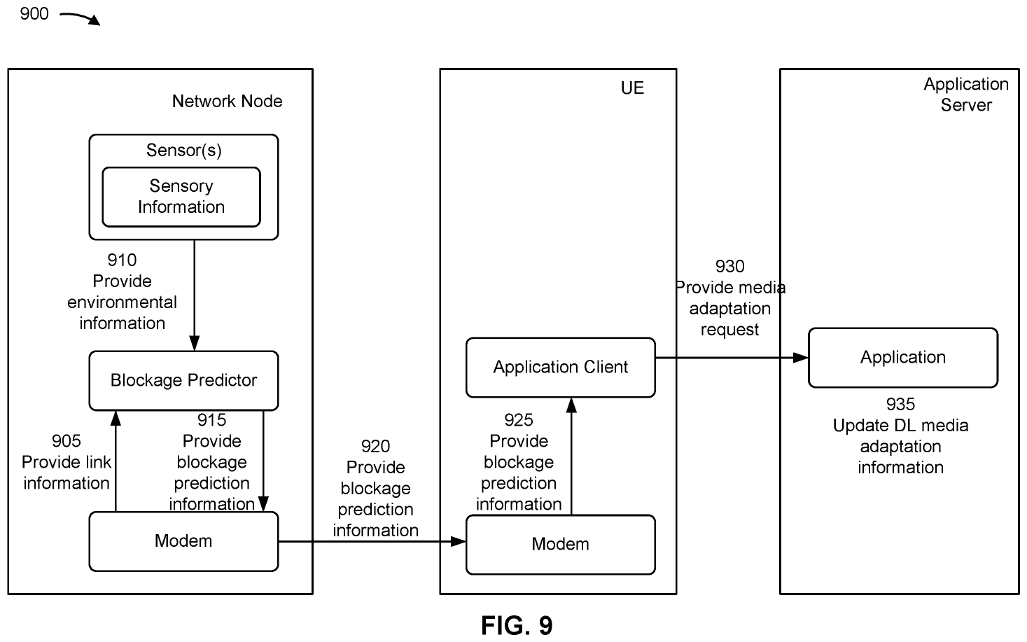

FIG. 9 is a diagram of an example 900 associated with predictive adaptation for a wireless link, in accordance with the present disclosure. As shown in FIG. 9, a UE may communicate with a network node (e.g., a network node 110, a CU, a DU, and/or an RU). In some aspects, the UE and the network node may be part of a wireless network (e.g., wireless network 100).

As shown in FIG. 9, and by reference number 905, a modem of the network node may provide a link information to a blockage predictor of the network node. The blockage predictor may include an entity of the network node that includes hardware of the network node, such as the modem, a processor, and/or memory of the network node.

As shown by reference number 910, one or more sensors of the network node may obtain sensory information and provide environmental information to the blockage predictor. In some aspects, the one or more sensors may include a camera, a radar, a lidar, and/or other device for detecting physical objects.

As shown by reference number 915, the blockage predictor may provide blockage prediction information to the modem of the network node. As shown by reference number 920, the modem of the network node may provide the blockage predication information (e.g., with or without adaptation from what was received from the blockage predictor) to a modem of the UE. As shown by reference number 925, the modem of the UE may provide the blockage prediction information to an application client of the UE.

As shown by reference number 930, the application client may provide a media adaptation request to an application server with an application having a link established for communicating with the UE via the network node. The application client may provide the media adaptation request to the application server via an application layer communication via the network node.

As shown by reference number 935, the application server may update downlink media adaptation information based at least in part on the media adaptation request.

As indicated above, FIG. 9 is provided as an example. Other examples may differ from what is described with respect to FIG. 9.

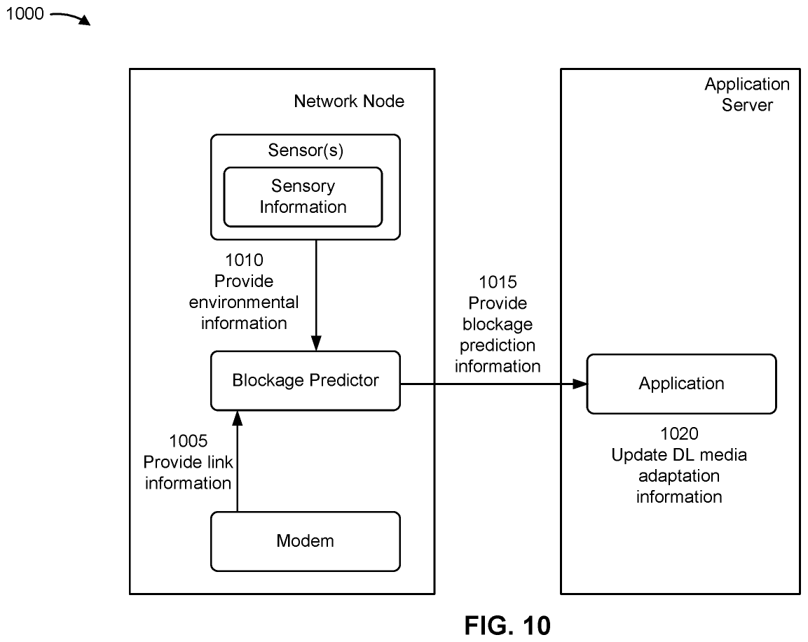

FIG. 10 is a diagram of an example 1000 associated with predictive adaptation for a wireless link, in accordance with the present disclosure. As shown in FIG. 10, a network node (e.g., a network node 110, a CU, a DU, and/or an RU) may communicate with an application server. In some aspects, the network node and the application server may be connected via a network of the network node and/or via the internet, among other examples.

As shown in FIG. 10, and by reference number 1005, a modem of the network node may provide a link information to a blockage predictor of the network node. The blockage predictor may include an entity of the network node that includes hardware of the network node, such as the modem, a processor, and/or memory of the network node.

As shown by reference number 1010, one or more sensors of the network node may obtain sensory information and provide environmental information to the blockage predictor. In some aspects, the one or more sensors may include a camera, a radar, a lidar, and/or other device for detecting physical objects.

As shown by reference number 1015, the blockage predictor may provide blockage prediction information to the application server with an application having a link established for communicating with a UE via the network node. The blockage predictor may provide the blockage prediction information to the application server via an application layer communication, a backhaul protocol communication, and/or a networking protocol communication, among other examples.

As shown by reference number 1020, the application server may update downlink media adaptation information based at least in part on the media adaptation request.

As indicated above, FIG. 10 is provided as an example. Other examples may differ from what is described with respect to FIG. 10.

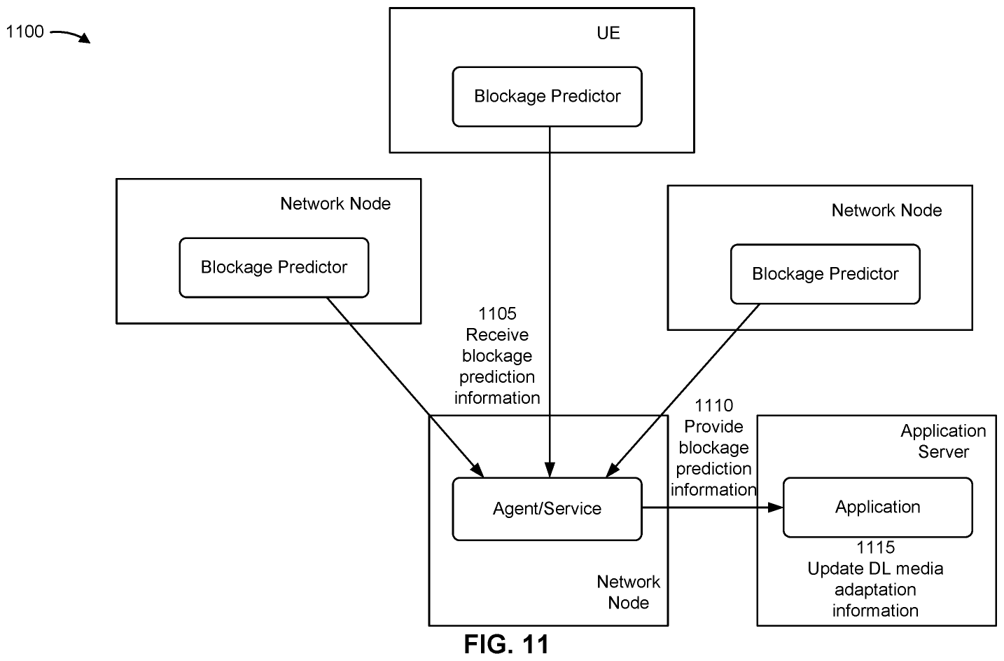

FIG. 11 is a diagram of an example 1100 associated with predictive adaptation for a wireless link, in accordance with the present disclosure. As shown in FIG. 11, network nodes (e.g., base stations 110, CUs, DUs, and/or RUs) and a UE may communicate with an application server and/or a network node having an agent/service associated with blockage prediction. In some aspects, the UE, the network nodes, and/or application server may be connected via a network of the network nodes and/or via the internet, among other examples. In some aspects, the network node having an agent/service associated with blockage prediction may include an edge node, an edge agent, and/or a core network service or function, among other examples.

As shown in FIG. 11, and by reference number 1105, the network node having an agent/service associated with blockage prediction may receive blockage prediction information from the network nodes and/or the UE. For example, the network node having an agent/service associated with blockage prediction may receive the blockage prediction information via one or more of the network nodes (e.g., RAN network nodes). In some aspects, the blockage prediction information may include contemporary information and/or historical information.

As shown by reference number 1110, the network node having an agent/service associated with blockage prediction may provide blockage prediction information to the application server with an application having a link established for communicating with a UE via the network node. The network node having an agent/service associated with blockage prediction may provide the blockage prediction information to the application server via an application layer communication, a backhaul protocol communication, and/or a networking protocol communication, among other examples.

As shown by reference number 1115, the application server may update downlink media adaptation information based at least in part on the media adaptation request.

In some aspects, the application server and/or the UE may subscribe to the network node having an agent/service associated with blockage prediction to receive the blockage prediction information.

As indicated above, FIG. 11 is provided as an example. Other examples may differ from what is described with respect to FIG. 11.

FIG. 12 is a diagram illustrating an example process 1200 performed, for example, by a first WCD, in accordance with the present disclosure. Example process 1200 is an example where the first WCD (e.g., UE 120 or network node 110) performs operations associated with predictive adaptation for a wireless link.

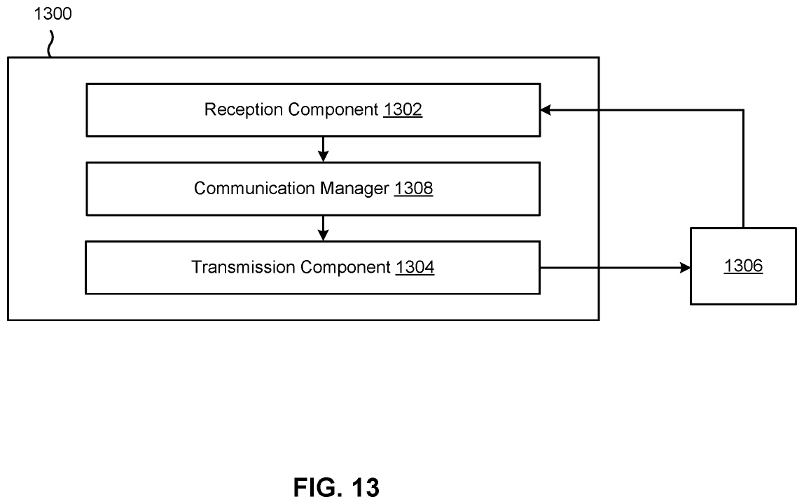

As shown in FIG. 12, in some aspects, process 1200 may include communicating a first set of data packets with a second WCD via a wireless link using a first set of one or more parameters (block 1210). For example, the first WCD (e.g., using communication manager 140 or 150, reception component 1302, and/or transmission component 1304 component, depicted in FIG. 13) may communicate a first set of data packets with a second WCD via a wireless link using a first set of one or more parameters, as described above.

As further shown in FIG. 12, in some aspects, process 1200 may include obtaining environmental information associated with an environment of the first WCD or the second WCD (block 1220). For example, the first WCD (e.g., using communication manager 140 or 150 and/or reception component 1302, depicted in FIG. 13) may obtain environmental information associated with an environment of the first WCD or the second WCD, as described above.

As further shown in FIG. 12, in some aspects, process 1200 may include detecting, based at least in part on the environmental information, a predicted increase of degradation of communications for a subsequent period of time, the predicted degradation of communications comprising one or more of a predicted increase of packet loss of communications, a predicted increase of latency to a multimedia layer of communications, or an increased latency to a codec layer of communications (block 1230). For example, the first WCD (e.g., using communication manager 140 or 150 and/or communication manager 1308, depicted in FIG. 13) may detect, based at least in part on the environmental information, a predicted increase of degradation of communications for a subsequent period of time, the predicted degradation of communications comprising one or more of a predicted increase of packet loss of communications, a predicted increase of latency to a multimedia layer of communications, or an increased latency to a codec layer of communications, as described above.

As further shown in FIG. 12, in some aspects, process 1200 may include communicating a second set of data packets with the second WCD via the wireless link using a second set of one or more parameters, the second set of one or more parameters based at least in part on detection of the predicted increase of degradation of communications (block 1240). For example, the first WCD (e.g., using communication manager 140 or 150, reception component 1302, and/or transmission component 1304 component, depicted in FIG. 13) may communicate a second set of data packets with the second WCD via the wireless link using a second set of one or more parameters, the second set of one or more parameters based at least in part on detection of the predicted increase of degradation of communications, as described above.

Process 1200 may include additional aspects, such as any single aspect or any combination of aspects described below and/or in connection with one or more other processes described elsewhere herein.

In a first aspect, obtaining the environmental information comprises obtaining the environmental information via a sensor associated with the first WCD, obtaining the environmental information from the second WCD, obtaining the environmental information from a third WCD, or obtaining the environmental information from a network node.

In a second aspect, alone or in combination with the first aspect, process 1200 includes transmitting, to the second WCD, an indication of the predicted increase of degradation of communications.

In a third aspect, alone or in combination with one or more of the first and second aspects, the indication of the predicted increase of degradation of communications comprises one or more of an indication of a start of the subsequent period of time, an indication of an end of the subsequent period of time, one or more metrics associated with the predicted increase of degradation of communications, or a requested data rate for the subsequent period of time.

In a fourth aspect, alone or in combination with one or more of the first through third aspects, communicating with the second WCD via the wireless link using a second set of one or more parameters based at least in part on detection of the predicted increase of degradation of communications comprises transmitting the second set of data packets to the second WCD using the second set of one or more parameters, or receiving the second set of data packets from the second WCD using the second set of one or more parameters based at least in part on transmitting, to the second WCD, an indication of the predicted increase of degradation of communications.

In a fifth aspect, alone or in combination with one or more of the first through fourth aspects, receiving the second set of data packets from the second WCD using the second set of one or more parameters comprises one or more of receiving, during the subsequent period of time, a first set of mitigating data packets with a reduced data rate relative the first set of data packets, receiving, before the subsequent period of time, a second set of mitigating data packets with an increased bandwidth relative to the first set of data packets, receiving, before the subsequent period of time, the second set of mitigating data packets including added intra-coded information relative to the first set of data packets, receiving, before the subsequent period of time, the second set of mitigating data packets including information associated with an image, with the information including parts of an image outside of a current view, receiving, before the subsequent period of time, the second set of mitigating data packets including information associated with the image, with the information including 3-dimensional information having widened coverage relative to the first set of data packets, or receiving, after the subsequent period of time, a third set of mitigating data packets including independently decodable frames of the image.

In a sixth aspect, alone or in combination with one or more of the first through fifth aspects, transmitting the second set of data packets to the second WCD using the second set of one or more parameters comprises one or more of transmitting, during the subsequent period of time, a first set of mitigating data packets with a reduced data rate relative the first set of data packets, transmitting, before the subsequent period of time, a second set of mitigating data packets with an increased bandwidth relative to the first set of data packets, transmitting, before the subsequent period of time, the second set of mitigating data packets including added intra-coded information relative to the first set of data packets, transmitting, before the subsequent period of time, the second set of mitigating data packets including information associated with an image, with the information including parts of an image outside of a current view, transmitting, before the subsequent period of time, the second set of mitigating data packets including information associated with the image, with the information including 3-dimensional information having widened coverage relative to the first set of data packets, or transmitting after the subsequent period of time, a third set of mitigating data packets including independently decodable frames of the image.

In a seventh aspect, alone or in combination with one or more of the first through sixth aspects, process 1200 includes providing an indication of the predicted increase of degradation of communications to an application server associated with the first set of data packets and the second set of data packets.

In an eighth aspect, alone or in combination with one or more of the first through seventh aspects, the first WCD comprises a UE and the second WCD comprises a network node, or wherein the second WCD comprises UE and the first WCD comprises a network node.

In a ninth aspect, alone or in combination with one or more of the first through eighth aspects, the environmental information includes parameters associated with one or more of obstacles in an environment of the first WCD or the second WCD, weathering in the environment, or interference in the environment.

In a tenth aspect, alone or in combination with one or more of the first through ninth aspects, process 1200 includes detecting an additional predicted increase of degradation of communications for an additional period of time for a third WCD associated with the environmental information, wherein obtaining the environmental information comprises receiving an indication of the environmental information from the second WCD.

In an eleventh aspect, alone or in combination with one or more of the first through tenth aspects, communicating the second set of data packets with the second WCD via the wireless link using the second set of one or more parameters comprises configuring an encoder or a decoder of the first WCD based at least in part on the predicted increase of degradation of communications for the subsequent period of time, configuring a split-rendering configuration for dividing processing of the second set of data packets between a network node and one of the first WCD or the second WCD, the split-rendering configuration based at least in part on the predicted increase of degradation of communications for the subsequent period of time.

In a twelfth aspect, alone or in combination with one or more of the first through eleventh aspects, detecting the predicted increase of degradation of communications for the subsequent period of time comprises predicting the increase of packet loss based at least in part on one or more of a position of the first WCD or the second WCD, an orientation of the first WCD or the second WCD, or a movement trajectory of the first WCD or the second WCD.

In a thirteenth aspect, alone or in combination with one or more of the first through twelfth aspects, the first set of data packets are associated with 2-dimensional image information, and wherein the second set of data packets are associated with 3-dimensional image information.

In a fourteenth aspect, alone or in combination with one or more of the first through thirteenth aspects, the first set of data packets are associated with audio input received at the first WCD or the second WCD, and wherein the second set of data packets are associated with predicted audio that is based at least in part on the audio input received at the first WCD or the second WCD.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a first WCD, or a first WCD may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include a communication manager 1308 (e.g., communication manager 140 or 150).

In some aspects, the apparatus 1300 may be configured to perform one or more operations described herein in connection with FIGS. 5-11. Additionally, or alternatively, the apparatus 1300 may be configured to perform one or more processes described herein, such as process 1200 of FIG. 12. In some aspects, the apparatus 1300 and/or one or more components shown in FIG. 13 may include one or more components of the first WCD described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the first WCD described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the first WCD described in connection with FIG. 2. In some aspects, the transmission component 1304 may be co-located with the reception component 1302 in a transceiver.

The reception component 1302 and/or the transmission component 1304 may communicate a first set of data packets with a second WCD via a wireless link using a first set of one or more parameters. The communication manager 1308 and/or the reception component 1302 may obtain environmental information associated with an environment of the first WCD or the second WCD. The communication manager 1308 and/or the reception component 1302 may detect, based at least in part on the environmental information, a predicted increase of degradation of communications for a subsequent period of time, the predicted degradation of communications comprising one or more of a predicted increase of packet loss of communications, a predicted increase of latency to a multimedia layer of communications, or an increased latency to a codec layer of communications. The reception component 1302 and/or the transmission component 1304 may communicate a second set of data packets with the second WCD via the wireless link using a second set of one or more parameters, the second set of one or more parameters based at least in part on detection of the predicted increase of degradation of communications.

The transmission component 1304 may transmit, to the second WCD, an indication of the predicted increase of degradation of communications.

The transmission component 1304 may provide an indication of the predicted increase of degradation of communications to an application server associated with the first set of data packets and the second set of data packets.

The reception component 1302 and/or the communication manager 1308 may detect an additional predicted increase of degradation of communications for an additional period of time for a third WCD associated with the environmental information wherein obtaining the environmental information comprises receiving an indication of the environmental information from the second WCD.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a first wireless communication device (WCD), comprising: communicating a first set of data packets with a second WCD via a wireless link using a first set of one or more parameters; obtaining environmental information associated with an environment of the first WCD or the second WCD; detecting, based at least in part on the environmental information, a predicted increase of degradation of communications for a subsequent period of time, the predicted degradation of communications comprising one or more of a predicted increase of packet loss of communications, a predicted increase of latency to a multimedia layer of communications, or an increased latency to a codec layer of communications; and communicating a second set of data packets with the second WCD via the wireless link using a second set of one or more parameters, the second set of one or more parameters based at least in part on detection of the predicted increase of degradation of communications.

Aspect 2: The method of Aspect 1, wherein obtaining the environmental information comprises: obtaining the environmental information via a sensor associated with the first WCD, obtaining the environmental information from the second WCD, obtaining the environmental information from a third WCD, or obtaining the environmental information from a network node.

Aspect 3: The method of Aspect 2, further comprising: transmitting, to the second WCD, an indication of the predicted increase of degradation of communications.

Aspect 4: The method of Aspect 3, wherein the indication of the predicted increase of degradation of communications comprises one or more of: an indication of a start of the subsequent period of time, an indication of an end of the subsequent period of time, one or more metrics associated with the predicted increase of degradation of communications, or a requested data rate for the subsequent period of time.

Aspect 5: The method of any of Aspects 1-4, wherein communicating with the second WCD via the wireless link using a second set of one or more parameters based at least in part on detection of the predicted increase of degradation of communications comprises: transmitting the second set of data packets to the second WCD using the second set of one or more parameters, or receiving the second set of data packets from the second WCD using the second set of one or more parameters based at least in part on transmitting, to the second WCD, an indication of the predicted increase of degradation of communications.

Aspect 6: The method of Aspect 5, wherein receiving the second set of data packets from the second WCD using the second set of one or more parameters comprises one or more of: receiving, during the subsequent period of time, a first set of mitigating data packets with a reduced data rate relative the first set of data packets; receiving, before the subsequent period of time, a second set of mitigating data packets with an increased bandwidth relative to the first set of data packets; receiving, before the subsequent period of time, the second set of mitigating data packets including added intra-coded information relative to the first set of data packets; receiving, before the subsequent period of time, the second set of mitigating data packets including information associated with an image, with the information including parts of an image outside of a current view; receiving, before the subsequent period of time, the second set of mitigating data packets including information associated with the image, with the information including 3-dimensional information having widened coverage relative to the first set of data packets; or receiving, after the subsequent period of time, a third set of mitigating data packets including independently decodable frames of the image.

Aspect 7: The method of Aspect 5, wherein transmitting the second set of data packets to the second WCD using the second set of one or more parameters comprises one or more of: transmitting, during the subsequent period of time, a first set of mitigating data packets with a reduced data rate relative the first set of data packets; transmitting, before the subsequent period of time, a second set of mitigating data packets with an increased bandwidth relative to the first set of data packets; transmitting, before the subsequent period of time, the second set of mitigating data packets including added intra-coded information relative to the first set of data packets; transmitting, before the subsequent period of time, the second set of mitigating data packets including information associated with an image, with the information including parts of an image outside of a current view; transmitting, before the subsequent period of time, the second set of mitigating data packets including information associated with the image, with the information including 3-dimensional information having widened coverage relative to the first set of data packets; or transmitting after the subsequent period of time, a third set of mitigating data packets including independently decodable frames of the image.

Aspect 8: The method of any of Aspects 1-7, further comprising: providing an indication of the predicted increase of degradation of communications to an application server associated with the first set of data packets and the second set of data packets.

Aspect 9: The method of any of Aspects 1-8, wherein the first WCD comprises a user equipment (UE) and the second WCD comprises a network node, or wherein the second WCD comprises a UE and the first WCD comprises a network node.

Aspect 10: The method of any of Aspects 1-9, wherein the environmental information includes parameters associated with one or more of: obstacles in an environment of the first WCD or the second WCD, weather in the environment, or interference in the environment.

Aspect 11: The method of any of Aspects 1-10, further comprising detecting an additional predicted increase of degradation of communications for an additional period of time for a third WCD associated with the environmental information, wherein obtaining the environmental information comprises receiving an indication of the environmental information from the second WCD.

Aspect 12: The method of any of Aspects 1-11, wherein communicating the second set of data packets with the second WCD via the wireless link using the second set of one or more parameters comprises: configuring an encoder or a decoder of the first WCD based at least in part on the predicted increase of degradation of communications for the subsequent period of time, configuring a split-rendering configuration for dividing processing of the second set of data packets between a network node and one of the first WCD or the second WCD, the split-rendering configuration based at least in part on the predicted increase of degradation of communications for the subsequent period of time.

Aspect 13: The method of any of Aspects 1-12, wherein detecting the predicted increase of degradation of communications for the subsequent period of time comprises predicting the increase of packet loss based at least in part on one or more of: a position of the first WCD or the second WCD, an orientation of the first WCD or the second WCD, or a movement trajectory of the first WCD or the second WCD.

Aspect 14: The method of any of Aspects 1-13, wherein the first set of data packets are associated with 2-dimensional image information, and wherein the second set of data packets are associated with 3-dimensional image information.

Aspect 15: The method of any of Aspects 1-14, wherein the first set of data packets are associated with audio input received at the first WCD or the second WCD, and wherein the second set of data packets are associated with predicted audio that is based at least in part on the audio input received at the first WCD or the second WCD.

Aspect 16: An apparatus for wireless communication at a device, comprising a processor; memory coupled with the processor; and instructions stored in the memory and executable by the processor to cause the apparatus to perform the method of one or more of Aspects 1-15.

Aspect 17: A device for wireless communication, comprising a memory and one or more processors coupled to the memory, the one or more processors configured to perform the method of one or more of Aspects 1-15.

Aspect 18: An apparatus for wireless communication, comprising at least one means for performing the method of one or more of Aspects 1-15.

Aspect 19: A non-transitory computer-readable medium storing code for wireless communication, the code comprising instructions executable by a processor to perform the method of one or more of Aspects 1-15.

Aspect 20: A non-transitory computer-readable medium storing a set of instructions for wireless communication, the set of instructions comprising one or more instructions that, when executed by one or more processors of a device, cause the device to perform the method of one or more of Aspects 1-15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first wireless communication device (WCD) for wireless communication, comprising:
a memory; and
one or more processors, coupled to the memory, configured to:
communicate a first set of data packets with a second WCD via a wireless link using a first set of one or more parameters;
obtain environmental information associated with an environment of the first WCD or the second WCD;
detect, based at least in part on the environmental information, a predicted increase of degradation of communications for a subsequent period of time, the predicted degradation of communications comprising one or more of a predicted increase of packet loss of communications, a predicted increase of latency to a multimedia layer of communications, or an increased latency to a codec layer of communications; and
communicate a second set of data packets with the second WCD via the wireless link using a second set of one or more parameters, the second set of one or more parameters based at least in part on detection of the predicted increase of degradation of communications.

2. The WCD of claim 1, wherein the one or more processors, to obtain the environmental information, are configured to:
obtain the environmental information via a sensor associated with the first WCD,
obtain the environmental information from the second WCD,
obtain the environmental information from a third WCD, or
obtain the environmental information from a network node.

3. The WCD of claim 2, wherein the one or more processors are further configured to:
transmit, to the second WCD, an indication of the predicted increase of degradation of communications.

4. The WCD of claim 3, wherein the indication of the predicted increase of degradation of communications comprises one or more of:
an indication of a start of the subsequent period of time,
an indication of an end of the subsequent period of time,
one or more metrics associated with the predicted increase of degradation of communications, or
a requested data rate for the subsequent period of time.

5. The WCD of claim 1, wherein the one or more processors, to communicate with the second WCD via the wireless link using a second set of one or more parameters based at least in part on detection of the predicted increase of degradation of communications, are configured to:
transmit the second set of data packets to the second WCD using the second set of one or more parameters, or
receive the second set of data packets from the second WCD using the second set of one or more parameters based at least in part on transmitting, to the second WCD, an indication of the predicted increase of degradation of communications.

6. The WCD of claim 5, wherein the one or more processors, to receive the second set of data packets from the second WCD using the second set of one or more parameters, are configured to:
receive, during the subsequent period of time, a first set of mitigating data packets with a reduced data rate relative the first set of data packets;
receive, before the subsequent period of time, a second set of mitigating data packets with an increased bandwidth relative to the first set of data packets;
receive, before the subsequent period of time, the second set of mitigating data packets including added intra-coded information relative to the first set of data packets;
receive, before the subsequent period of time, the second set of mitigating data packets including information associated with an image, with the information including parts of an image outside of a current view;
receive, before the subsequent period of time, the second set of mitigating data packets including information associated with the image, with the information including 3-dimensional information having widened coverage relative to the first set of data packets; or
receive, after the subsequent period of time, a third set of mitigating data packets including independently decodable frames of the image.

7. The WCD of claim 5, wherein the one or more processors, to transmit the second set of data packets to the second WCD using the second set of one or more parameters, are configured to:
transmit, during the subsequent period of time, a first set of mitigating data packets with a reduced data rate relative the first set of data packets;
transmit, before the subsequent period of time, a second set of mitigating data packets with an increased bandwidth relative to the first set of data packets;
transmit, before the subsequent period of time, the second set of mitigating data packets including added intra-coded information relative to the first set of data packets;
transmit, before the subsequent period of time, the second set of mitigating data packets including information associated with an image, with the information including parts of an image outside of a current view;
transmit, before the subsequent period of time, the second set of mitigating data packets including information associated with the image, with the information including 3-dimensional information having widened coverage relative to the first set of data packets; or
transmit after the subsequent period of time, a third set of mitigating data packets including independently decodable frames of the image.

8. The WCD of claim 1, wherein the one or more processors are further configured to:
provide an indication of the predicted increase of degradation of communications to an application server associated with the first set of data packets and the second set of data packets.

9. The WCD of claim 1, wherein the first WCD comprises a user equipment (UE) and the second WCD comprises a network node, or
wherein the second WCD comprises a UE and the first WCD comprises a network node.

10. The WCD of claim 1, wherein the environmental information includes parameters associated with one or more of:
obstacles in an environment of the first WCD or the second WCD,
weather in the environment, or
interference in the environment.

11. The WCD of claim 1, wherein the one or more processors are further configured to detect an additional predicted increase of degradation of communications for an additional period of time for a third WCD associated with the environmental information,
wherein the one or more processors, to obtain the environmental information, are configured to receive an indication of the environmental information from the second WCD.

12. The WCD of claim 1, wherein the one or more processors, to communicate the second set of data packets with the second WCD via the wireless link using the second set of one or more parameters, are configured to:
configure an encoder or a decoder of the first WCD based at least in part on the predicted increase of degradation of communications for the subsequent period of time,
configure a split-rendering configuration for dividing processing of the second set of data packets between a network node and one of the first WCD or the second WCD, the split-rendering configuration based at least in part on the predicted increase of degradation of communications for the subsequent period of time.

13. The WCD of claim 1, wherein the one or more processors, to detect the predicted increase of degradation of communications for the subsequent period of time, are configured to predict the increase of packet loss based at least in part on one or more of:
a position of the first WCD or the second WCD,
an orientation of the first WCD or the second WCD, or
a movement trajectory of the first WCD or the second WCD.

14. The WCD of claim 1, wherein the first set of data packets are associated with 2-dimensional image information, and
wherein the second set of data packets are associated with 3-dimensional image information.

15. The WCD of claim 1, wherein the first set of data packets are associated with audio input received at the first WCD or the second WCD, and
wherein the second set of data packets are associated with predicted audio that is based at least in part on the audio input received at the first WCD or the second WCD.

16. A method of wireless communication performed by a first wireless communication device (WCD), comprising:
communicating a first set of data packets with a second WCD via a wireless link using a first set of one or more parameters;
obtaining environmental information associated with an environment of the first WCD or the second WCD;
detecting, based at least in part on the environmental information, a predicted increase of degradation of communications for a subsequent period of time, the predicted degradation of communications comprising one or more of a predicted increase of packet loss of communications, a predicted increase of latency to a multimedia layer of communications, or an increased latency to a codec layer of communications; and
communicating a second set of data packets with the second WCD via the wireless link using a second set of one or more parameters, the second set of one or more parameters based at least in part on detection of the predicted increase of degradation of communications.

17. The method of claim 16, wherein obtaining the environmental information comprises:
obtaining the environmental information via a sensor associated with the first WCD,
obtaining the environmental information from the second WCD,
obtaining the environmental information from a third WCD, or
obtaining the environmental information from a network node.

18. The method of claim 17, further comprising:
transmitting, to the second WCD, an indication of the predicted increase of degradation of communications.

19. The method of claim 18, wherein the indication of the predicted increase of degradation of communications comprises one or more of:
an indication of a start of the subsequent period of time,
an indication of an end of the subsequent period of time,
one or more metrics associated with the predicted increase of degradation of communications, or
a requested data rate for the subsequent period of time.

20. The method of claim 16, wherein communicating with the second WCD via the wireless link using a second set of one or more parameters based at least in part on detection of the predicted increase of degradation of communications comprises:
transmitting the second set of data packets to the second WCD using the second set of one or more parameters, or
receiving the second set of data packets from the second WCD using the second set of one or more parameters based at least in part on transmitting, to the second WCD, an indication of the predicted increase of degradation of communications.

21. The method of claim 20, wherein receiving the second set of data packets from the second WCD using the second set of one or more parameters comprises one or more of:
receiving, during the subsequent period of time, a first set of mitigating data packets with a reduced data rate relative the first set of data packets;
receiving, before the subsequent period of time, a second set of mitigating data packets with an increased bandwidth relative to the first set of data packets;
receiving, before the subsequent period of time, the second set of mitigating data packets including added intra-coded information relative to the first set of data packets;
receiving, before the subsequent period of time, the second set of mitigating data packets including information associated with an image, with the information including parts of an image outside of a current view;
receiving, before the subsequent period of time, the second set of mitigating data packets including information associated with the image, with the information including 3-dimensional information having widened coverage relative to the first set of data packets; or
receiving, after the subsequent period of time, a third set of mitigating data packets including independently decodable frames of the image.

22. The method of claim 20, wherein transmitting the second set of data packets to the second WCD using the second set of one or more parameters comprises one or more of:
transmitting, during the subsequent period of time, a first set of mitigating data packets with a reduced data rate relative the first set of data packets;
transmitting, before the subsequent period of time, a second set of mitigating data packets with an increased bandwidth relative to the first set of data packets;
transmitting, before the subsequent period of time, the second set of mitigating data packets including added intra-coded information relative to the first set of data packets;
transmitting, before the subsequent period of time, the second set of mitigating data packets including information associated with an image, with the information including parts of an image outside of a current view;
transmitting, before the subsequent period of time, the second set of mitigating data packets including information associated with the image, with the information including 3-dimensional information having widened coverage relative to the first set of data packets; or
transmitting after the subsequent period of time, a third set of mitigating data packets including independently decodable frames of the image.

23. The method of claim 16, further comprising:
providing an indication of the predicted increase of degradation of communications to an application server associated with the first set of data packets and the second set of data packets.

24. The method of claim 16, wherein the first WCD comprises a user equipment (UE) and the second WCD comprises a network node, or
wherein the second WCD comprises a UE and the first WCD comprises a network node.

25. The method of claim 16, wherein the environmental information includes parameters associated with one or more of:
obstacles in an environment of the first WCD or the second WCD,
weather in the environment, or
interference in the environment.

26. The method of claim 16, wherein communicating the second set of data packets with the second WCD via the wireless link using the second set of one or more parameters comprises:
configuring an encoder or a decoder of the first WCD based at least in part on the predicted increase of degradation of communications for the subsequent period of time,
configuring a split-rendering configuration for dividing processing of the second set of data packets between a network node and one of the first WCD or the second WCD, the split-rendering configuration based at least in part on the predicted increase of degradation of communications for the subsequent period of time.

27. The method of claim 16, wherein detecting the predicted increase of degradation of communications for the subsequent period of time comprises predicting the increase of packet loss based at least in part on one or more of:
a position of the first WCD or the second WCD,
an orientation of the first WCD or the second WCD, or
a movement trajectory of the first WCD or the second WCD.

28. The method of claim 16, wherein the first set of data packets are associated with 2-dimensional image information, and
wherein the second set of data packets are associated with 3-dimensional image information.

29. A non-transitory computer-readable medium storing a set of instructions for wireless communication, the set of instructions comprising:
one or more instructions that, when executed by one or more processors of a first wireless communication device (WCD), cause the WCD to:
communicate a first set of data packets with a second WCD via a wireless link using a first set of one or more parameters;
obtain environmental information associated with an environment of the first WCD or the second WCD;
detect, based at least in part on the environmental information, a predicted increase of degradation of communications for a subsequent period of time, the predicted degradation of communications comprising one or more of a predicted increase of packet loss of communications, a predicted increase of latency to a multimedia layer of communications, or an increased latency to a codec layer of communications; and
communicate a second set of data packets with the second WCD via the wireless link using a second set of one or more parameters, the second set of one or more parameters based at least in part on detection of the predicted increase of degradation of communications.

30. An apparatus for wireless communication, comprising:
means for communicating a first set of data packets with a second WCD via a wireless link using a first set of one or more parameters;
means for obtaining environmental information associated with an environment of the first WCD or the second WCD;
means for detecting, based at least in part on the environmental information, a predicted increase of degradation of communications for a subsequent period of time, the predicted degradation of communications comprising one or more of a predicted increase of packet loss of communications, a predicted increase of latency to a multimedia layer of communications, or an increased latency to a codec layer of communications; and
means for communicating a second set of data packets with the second WCD via the wireless link using a second set of one or more parameters, the second set of one or more parameters based at least in part on detection of the predicted increase of degradation of communications.
